(19) United States
(12) Patent Application Publication
(10) Pub. No.: US 2006/0289448 A1
(43) Pub. Date: Dec. 28, 2006

(54) Heater for semiconductor manufacturing device and heating device equipped with the same

(75) Inventors: Masuhiro Natsuhara, Itami-shi (JP); Hirohiko Nakata, Itami-shi (JP); Akira Kuibira, Osaka-shi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Sumitomo Electric Industries, Ltd., Osaka-shi (JP)

(21) Appl. No.: 11/283,164

(22) Filed: Nov. 21, 2005

(30) Foreign Application Priority Data
Nov. 8, 2004 (JP) 323246/2004

(51) Int. Cl. H05B 3/68

(52) U.S. Cl. 219/444.1; 118/724

(57) ABSTRACT

A heater is provided with which the temperature distribution from cooling start to cooling end can be made more uniform, as well as an device provided which the same. The heater includes a heating surface for heating a heating-subject article that is placed on the heating surface or separated a fixed distance from it, a resistive heating element on a surface of or inside a base material constituting the heater, and an isothermal plate on a side opposite the heating surface. The material of the isothermal plate includes copper or a copper alloy, or alternatively aluminum or an aluminum alloy as a main component. Thus, the heater can suppress a temperature drop in the instant a cold wafer is placed on it, and can perform swift temperature recovery.

### TECHNICAL FIELD

The present invention relates to heaters on which heating-subject articles are loaded to undergo heat processes, and to devices in which such heaters are installed. More specifically, the present invention relates to heaters that can be advantageously used in semiconductor manufacturing equipment, where they are especially used for heat-treating semiconductor wafers, and to heating devices in which the heaters are installed.

### BACKGROUND ART

Conventionally, in a semiconductor manufacturing operation, the semiconductor substrate (wafer) serving as the workpiece is subjected to various processes, such as film deposition processes and etching processes. In semiconductor manufacturing equipment in which such processes are carried out on semiconductor substrates, heaters are used in order to retain semiconductor substrates and to heat the semiconductor substrates.

During a photolithography operation, for example, a resist film pattern is formed on a wafer. In this operation, after the wafer is washed, it is heat-dried and cooled. Then the resist film is applied to the wafer surface, the wafer is placed on the heater inside the photolithography processing device, and after it has dried, the wafer is subject exposure, developing, and related processes. Because the temperature during the drying of the resist considerably affects the quality of the film in the photolithography operation, the uniformity of the temperature of the heater during the processes is important.

In order to raise the throughput in these wafer processes, furthermore, demands are to complete them in the shortest possible time. Therefore, inventors and other researchers have been investigating semiconductor manufacturing equipment that has cooling means for cooling down heated heaters in a short time. For example, in Japanese Unexamined Pat. App. Pub. No. 2004-014655, a semiconductor manufacturing device that includes a cooling module that can be abutted against and separated from the surface of the heater on the side opposite the surface on which the wafer is placed has been proposed.

Also, in Japanese Unexamined Pat. App. Pub. No. 2005-150506, a semiconductor manufacturing device in which coolant flow channels are formed in a cooling module to further improve the cooling speed and to maintain uniformity of the heater temperature from cooling start until cooling end has been proposed.

### DISCLOSURE OF INVENTION

In electronic device and like semiconductor manufacturing processes lately, even greater uniformity of the temperature distribution in the heater is being called for; highest uniformity in heater temperature distribution is as a matter of course demanded during heat retention, is also demanded in the interval from cooling start until cooling end. Also, demands are for further improvement ramp-up and cool-down speed as well.

Accompanying the latest microscaling of semiconductor circuit paths, KrF and ArF have come into use as light sources for exposure in the photolithography operation, with chemically amplified films being used as resist films. In this operation acid generated during exposure acts as a catalyst, and the resist film is solubilized during the ensuing development process, allowing it to be washed away. Due to temperature in the PEB (Post Exposure Baking: solidifying the resist film after exposure) process, in which the resist film is hardened following exposure, the acid diffuses, the amount by which its travels strongly depending on the temperature. For this reason, in order to improve pattern accuracy in photolithography it is necessary to strictly control the hardening temperature of the resist. In pre-exposure PAB (Post Applied Baking: a operation in which, after resist film coating in a spinner, viscosity is increased by evaporating solvent in order to prevent flow at exposure time) operation, it is necessary to strictly control temperature because the post-exposure diffusion of acid is influenced by the viscosity of the resist film. Because reactions in the PEB, PAB, and other processes occur also in the course of ramp-up, with temperature variations strongly influencing pattern accuracy, it is necessary to strictly control temperature variations in the course of ramp-up as well.

In implementations in which wafers are processed one at a time in a piece-wise fashion, in order to increase throughput, the wafers are processed at a pace on the order of, for example, one per minute, such that the heaters heating the wafers cannot be heated over a long time period to stabilize them. Thus, following the drop in temperature on loading a wafer, swift ramping-up and rapid stabilizing of temperature variations are demanded of heaters used in PEB, PAB, and like operations.

However, although with present heaters a comparatively favorable temperature distribution is exhibited once the heater temperature is in a steady state, forming ideal microscale conductor patterns has been difficult owing to the large variations in heater inside temperature during heater ramp-up, as just noted.

Accordingly, an object of the present invention is to make available a heater that makes the temperature distribution in the interval from cooling start to cooling end more uniform, as well as a device in which the heater is installed.

The present inventors, as the accumulated result of concerted research to solve the aforementioned problems, have found that the temperature distribution within the heater is improved compared to the conventionally known by installing along the heater side opposite its wafer carrying side an isothermal plate comprising copper or a copper alloy, or alternatively aluminum or an aluminum alloy as a main component.

In particular, in a heater having a heating surface for heating a heating-subject article that is placed on the heating surface or separated a fixed distance from it, rendering the heater to have a resistive heating element on a surface of or inside a base material constituting the heater, and to have an isothermal plate on the heater side opposite its heating surface, with the isothermal plate substance being copper or a copper alloy, or alternatively aluminum or an aluminum alloy as a main component, instantaneous temperature drop when a cold wafer is set onto the heater is curbed such that return of the temperature can occur swiftly.

The isothermal plate, by so comprising copper or a copper alloy, or alternatively aluminum or an aluminum alloy as a main component, can in its planar orientation quickly diffuse heat, whereby heater and wafer are swiftly made thermally uniform. The high specific heat provides a large heat capacity, and due to the high thermal conductivity, temperature uniformization through fast thermal diffusion is made possible.

It is preferable that an antioxidant coating is formed on a surface of the isothermal plate, the antioxidant coating preferably comprising nickel as a main component. Also, the isothermal plate preferably has a thickness of at least 5 mm; furthermore the isothermal plate preferably has a thickness of at most 20 mm.

By any one of alumina, silicon nitride, silicon carbide, and aluminum nitride being a main component of the base material that constitutes the heater, it acquires isothermal properties, heat resistance, durability, and thermal shock resistance due to its high thermal conductivity. By aluminum nitride being a main component of the base material that constitutes the heater, it acquires in particular excellent isothermal properties and thermal shock resistance.

Also, if the resistive heating element is divided into a plurality of zones, each zone respectively being enabled to be independently controlled, thermal equalization is facilitated by providing more electric power for heating to zones with low temperature.

Further installing a cooling module makes it possible to increase the cooling speed at cooling time, which makes it possible to increase throughput. By allowing coolant to circulate in the cooling module, more efficient cooling due to the coolant is made possible.

Also, by supplementing the isothermal plate with a heating function, temperature variations of the isothermal plate itself can be corrected. Furthermore, if the heat generation capacity of the heating function of the isothermal plate is large at a periphery of the isothermal plate, temperature variations due to heat escaping from the periphery can be corrected.

By providing a semiconductor manufacturing device that contains, in a metal casing, a heater for semiconductor manufacturing equipment as above, exposure to environmental fluctuations is restrained.

### BRIEF DESCRIPTION OF DRAWINGS

FIG. 1 is a cross-sectional schematic depiction of an example of a heater of the present invention.

FIG. 2 is a cross-sectional schematic depiction of another example of a heater of the present invention.

### BEST MODE FOR CARRYING OUT THE INVENTION

In a heater comprising a heating surface for heating a heating-subject article that is placed on the heating surface or separated a fixed distance from it, ordinarily, for example if the shape of the heater is cylindrical, a resistive heating element arranged at a surface of or inside a heater base material constituting the heater forms patterns of concentric circles, spirals, and the like. Then, by feeding current through the resistive heating element, the temperature of the heater base plate is raised. If after heating, the temperature distribution in the stationary state is uniform, it is necessary to choose a design with enhanced heat generation at the periphery, due to the edge of the heater base plate being present. Therefore, when starting ramp-up of the heater base plate from a predetermined temperature, the temperature at the periphery of the heater base plate unavoidably builds up faster than the interior so that temperature variations becomes large, which is extremely undesirable when treating wafers.

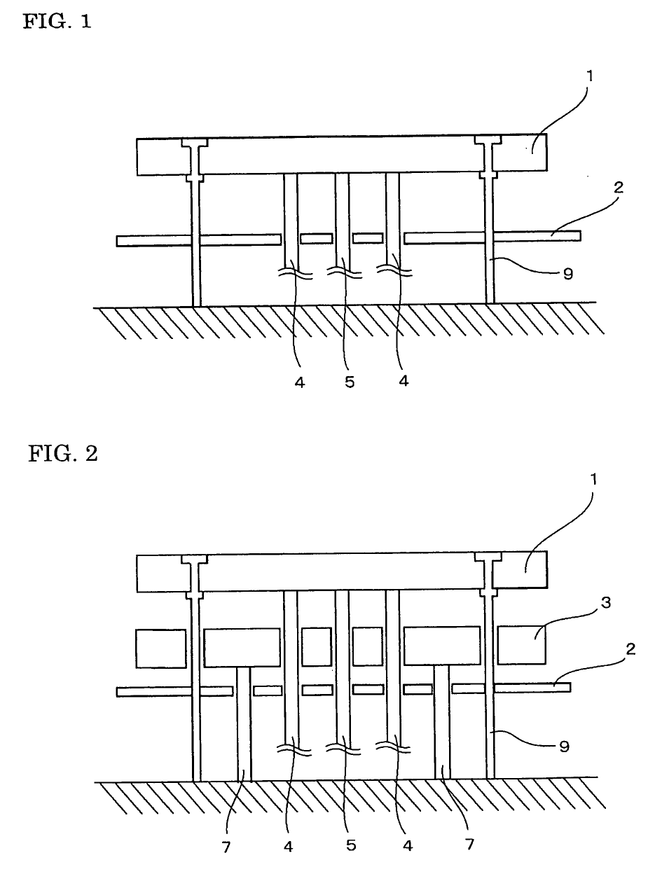

Accordingly, in the present invention, as shown in FIG. 1, an isothermal plate 2 comprising copper or a copper alloy, or alternatively aluminum or an aluminum alloy as a main component is arranged on the side opposite the heating surface of the heater base plate 1. By arranging the isothermal plate in this way in the heater, the temperature drop in the instant a wafer is placed on the heater is kept low, and the temperature quickly returns to the set value.

Needless to say, with the heater of the present invention, the temperature distribution can be equalized not only in transitional states as described above but also in stationary states. That is, as far as temperature non-uniformities in the heater are concerned, the temperature in the heater is easily equalized, because due to the isothermal plate of the present invention, heat can readily transfer from regions of low temperature to regions of high temperature.

As a preferred embodiment, it is preferable that the outer diameter of the isothermal plate is roughly equal to the outer diameter of the heater base plate, because this way, transfer of the entire heat within the heater can be realized smoothly. Conversely, if the isothermal plate is considerably larger than the heater base plate, it functions as a heat radiation fin, which is undesirable because it causes a lowering of temperature in the periphery. More specifically, if the heater base plate is cylindrical, then it is preferable that the size of the isothermal plate is within about 10% of the diameter of the heater base plate. That is, if the heater base plate has a diameter of 340 mm, then it is preferable that the diameter of the isothermal plate is 374 mm or less. It is furthermore undesirable that the isothermal plate is smaller than the heater base plate because in that case, heat transfer at the periphery is performed exclusively within the heater, and the effect of heat transfer in the isothermal plate cannot be taken advantage of, so that it becomes difficult for the temperature distribution at the periphery and in the interior to become uniform. More specifically, as in the case that the isothermal plate is larger than the heater base plate, a difference of 10% or less is preferred, amounting to an isothermal plate of at least 306 mm.

Also, it is preferable that an antioxidant coating is formed on the surface of the isothermal plate. It is particularly preferable that the antioxidant coating is plating of nickel (Ni) or gold (Au). By forming the antioxidant coating, oxidation, thermal degradation and the like are prevented, and if the material of the isothermal plate is a material unfavorable to the wafer, an antioxidant coating is preferable also because constituent material of the isothermal plate does not appear at the surface so that impurities are prevented.

Also, it is preferable that the thickness of the isothermal plate is at least 5 mm. Although isothermal properties are improved if the thickness is less than 5 mm, the effect is small. Also, it is preferable that the thickness of the isothermal plate is at most 20 mm. It is undesirable if the thickness exceeds 20 mm, because conversely the heat capacity becomes too large and the isothermal properties decline.

For the fixation of isothermal plate and heater base plate various methods can be considered, but in order to absorb the difference in the coefficients of thermal expansion between the isothermal plate and the heater base plate through holes without tapping are formed on the side of the heater base plate and on the side of the isothermal plate, enabling fixation with bolts 9 and nuts from both sides. At this time it is necessary to leave gaps between the fixation bolts and each through hole, the gaps being sufficient to absorb the expansion difference due to thermal expansion. Also, by inserting washers between the bolts and nuts, the thermal expansion difference can be absorbed better.

In the present invention, it is particularly preferable that copper or a copper alloy is used for the thermal equalization plate, because it excels in improving the isothermal properties. It is also preferable to use aluminum or an aluminum alloy, because this makes it possible to reduce the weight of the isothermal plate. These materials may be chosen depending on application and goals.

While there are no particular restrictions regarding the material of the heater base plate of the present invention, ceramics are preferred. If a metal is used as material of the heater base plate, particles tend to emerge due to friction and rub-off between the heating-subject article and the heater base plate. Particularly if the heating-subject article is a silicon wafer, this is undesirable, because since the hardness of the silicon wafer is greater than that of metal, there is a problem of particles emerging in particular due to friction and rub-off with a metal heater, the particles again sticking to the wafer and generating failures.

However, because in general ceramics have greater hardness than silicon they can drastically reduce the occurrence of particles due to abrasion and friction, making them preferable. Any kind of ceramics may be chosen as the material used for the heater base plate. Particularly preferable are ceramics with as few pores and other defects as possible, because this way the occurrence of particles as described above is suppressed. Porosity of 1% or less makes it possible to suppress the emergence of particles and is therefore particularly preferable.

Conversely, it is undesirable that the porosity exceeds 1%, because, due to friction and rub-off between edges of porous portions on the surface and placed objects such as wafers, the edges of the porous portions in the ceramic material fall off more easily, and particles tend to be generated. As long as its porosity is 1% or less, an appropriate material may be chosen according to its use.

First, when attaching the greatest importance to the uniformity of the temperature distribution of the heating surface of the heater base plate, aluminum nitride and silicon carbide, which have high thermal conductivity, are preferred. When attaching the greatest importance to mechanical strength and other aspects of reliability, silicon nitride is preferred because of its high strength and resilience to thermal shock. And when attaching the greatest importance to cost, aluminum oxide is preferred.

Even among these ceramics, aluminum nitride (AlN) is well suited when taking the balance of performance and cost into consideration. Below, a manufacturing method of a heater of the present invention is described in detail for the case of AlN.

For AlN raw material powder, a relative surface area of 2.0 to 5.0 m²/g is preferable. If the relative surface area is less than 2.0 m²/g, its sintering properties deteriorate because the aluminum nitride grains are relatively large. Consequently, sintering is possible only at sintering temperatures exceeding 2000° C., which is undesirable because, for example, if a carbon-based oven is used as a sintering oven, the carbon vapor pressure during the sintering rises, and the speed of degradation of the carbon increases.

Also, when the relative surface area exceeds 5.0 m²/g, the cohesion of the powder becomes extremely strong, making it difficult to handle. That is, it is also undesirable, because when the relative surface area becomes too large, since cohesion is strengthened, mixing properties with auxiliary sintering agents deteriorate, and the sintering temperature rises. It is furthermore undesirable because a larger relative surface area of the powder leads to an increase of the relative amount of oxygen present at the surface of the AlN powder, followed by a decline in thermal conductivity of the sintered piece.

Furthermore, it is preferable that the amount of oxygen contained in the raw material powder is 2 wt. % or less. When the amount of oxygen exceeds 2 wt. %, the thermal conductivity of the sintered piece declines. Also, it is preferable that the amount of non-aluminum metal impurities contained in the raw material powder is not more than 2000 ppm. When the amount of metal impurities exceeds this range, the thermal conductivity of the sintered piece declines. Because, among metal impurities, Si and other IV group elements as well as Fe and other iron group elements have a particularly strong effect of lowering the thermal conductivity of the sintered piece, the content of each of these is preferably not more than 500 ppm.

Since AlN is a material that is difficult to sinter, it is preferable to add an auxiliary sintering agent to the AlN raw material powder. As auxiliary sintering agents to be added, rare-earth compounds are preferred. The rare-earth compounds react during sintering with aluminum oxide, or aluminum nitrite and nitrate compounds that are present on the surface of the grains of the aluminum nitride powder and thus can improve the thermal conductivity of the sintered aluminum nitride piece because besides promoting dense packing of the aluminum nitride they also have the capacity of removing oxygen, which is the cause of the decline in thermal conductivity of the AlN sintered piece.

Among rare-earth compounds, yttrium compounds whose oxygen-removing capacity is particularly high are preferred. Preferably, the added amount is 0.01 to 5 wt. %. If it is less than 0.01 wt. %, a densely packed sintered piece is hard to obtain, and the thermal conductivity of the sintered piece declines. Also, if it exceeds 5 wt. %, auxiliary sintering agent comes to be present at the grain boundaries of the sintered aluminum nitride piece, so that if it is used in a corrosive atmosphere, the auxiliary sintering agent at the grain boundaries is etched, causing flaking and particles. Even more preferable is an added amount of auxiliary sintering agent of not more than 1 wt. %. If it is not more than 1 wt. %, corrosion resistance improves because the amount of auxiliary sintering agent at triple points of the grain boundaries is drastically reduced.

Also, as rare-earth compounds, nitrogen compounds, fluorite compounds, stearate compounds and the like may be used oxides. Among these, oxides are preferred as being low-priced and easily obtained. Also, because stearate compounds have a high affinity with organic solvents, they are particularly suitable if the aluminum nitride raw material powder, the auxiliary sintering agent and the like are mixed with an organic solvent, because mixing properties improve.

Next, predetermined amounts of solvent and binder, and, if necessary, dispersion agents and mixing agents are added to the aluminum nitride raw material powder and the auxiliary sintering agent powder, and mixed. As mixing technique, ball mill mixing, ultrasonic mixing and others are possible. From such mixing, a raw material slurry can be obtained.

By shaping and sintering the obtained slurry, a sintered aluminum nitride piece may be obtained. Two kinds of methods, the co-fired and the post-metallization method are possible.

First, the post-metallization method is explained. From the foregoing slurry, granules are made by spray-drying or a similar technique. These granules are inserted into a die fixture, and press-forming is conducted. At this time a pressure of at least 9.8 MPa is desirable. At a pressure of less than 9.8 MPa, often a formed piece with sufficient strength cannot be obtained so that it is easily damaged during handling and the like.

For the density of the formed piece, although depending on the amount of binder contained and the amount of auxiliary sintering agent added, at least 1.5 g/cm³ is preferred. If it is less than 1.5 g/cm³, sintering is hampered because the distances between the grains of the raw material powder become relatively large. Also, the formed piece density is preferably not greater than 2.5 g/cm³. If it is greater than 2.5 g/cm³, it becomes difficult in the ensuing process of degreasing to remove the binder sufficiently from inside the formed piece. Therefore, the amount of carbon in the defatted piece becomes relatively large, and since this carbon obstructs the sintering of AlN, it becomes difficult to obtain a densely packed sintered piece, as mentioned above.

Next, the formed piece is subjected to degreasing treatment by heating it in non-oxidant atmosphere. When performing degreasing in air or the like, the surface of the AlN powder is oxidized, causing the thermal conductivity of the sintered piece to decline. As a gas for the non-oxidizing atmosphere, Nitrogen and Argon are preferred. The heating temperature for the degreasing treatment is preferably in the range of 500° C. to 1000° C. At a temperature of less than 500° C. the binder cannot be sufficiently removed, causing carbon to excessively remain in the formed piece after the degreasing treatment, which obstructs sintering in the ensuing sintering process. Also, at a temperature exceeding 1000° C., because the remaining amount of carbon becomes too small, the ability to remove oxygen of the oxide coat that is present on the AlN powder surface declines, and the thermal conductivity of the sintered piece declines.

Also, preferably the amount of carbon remaining in the formed piece after the degreasing treatment is not more than 1.0 wt. %. When carbon remains in excess of 1.0 wt. %, the sintering is obstructed and a densely packed sintered piece cannot be obtained.

Next, sintering is performed. The sintering is performed in a non-oxidant atmosphere of nitrogen, argon and the like, at a temperature of 1700 to 2000° C. At this time, the moisture contained in the atmosphere gas, such as nitrogen, preferably corresponds to a dewpoint of not more than −30° C. If a greater amount of moisture is contained, because the AlN reacts during the sintering with the moisture in the atmosphere gases, forming oxygen-nitrogen compounds, it is possible that the thermal conductivity declines. Also, preferably the amount of oxygen in the atmosphere gas is not more than 0.001 vol. %. When the amount of oxygen is greater, the AlN surface oxidizes, and it is possible that the thermal conductivity declines.

Furthermore, as a jig used during sintering, a cast of boron nitride (BN) is ideal. Because such a BN cast, in addition to sufficient thermal resistance to the abovementioned sintering temperatures, has surfaces with solid lubricant properties, it can diminish friction between the jig and the cast when the cast shrinks during sintering. Therefore, sintered pieces with little strain, and thus with little deformation, may be obtained.

The sintered piece obtained is processed as necessary. If the ensuing process is screen-printing electrically conductive paste, a surface roughness Rₐ of the sintered piece of not more than 5 μm is preferable. When exceeding 5 μm, pattern seep-out, pinholes and other defects emerge more easily during circuit formation by screen-printing. A surface roughness Rₐ of 1 μm or less is even more preferable.

When treating the above-mentioned surface roughness by polishing, letting alone the case of screen-printing on both faces of the sintered piece, also in the case of applying screen-printing to one face only, it is better to also polish the face on the opposite side of the face to be screen-printed. If only the face to be screen-printed is polished, the unpolished face acts as support for the sintered piece during screen-printing. At this time, because bumps and foreign substances may be present on the unpolished face, the fixation of the sintered piece may become unstable, and the circuit pattern may not be successfully screen-printed.

Also, at this time, preferably the parallelism of both treated faces is not greater than 0.5 mm. When the parallelism exceeds 0.5 mm, the variation of the thickness of the electrically conductive paste may become large. A parallelism of not more than 0.1 mm is particularly suitable. Furthermore, preferably the flatness of the face to be screen-printed is not greater than 0.5 mm. Also in the case of the flatness exceeding 0.5 mm, the variation of the thickness of the electrically conductive paste may become large. Also a flatness of not more than 0.1 mm is particularly suitable.

The electrically conductive paste is applied to the sintered piece by screen-printing, thereby forming an electric circuit. The conductive paste may be obtained by mixing metal powder and, depending on necessity, oxide powder, binder, and solvent. For the metal powder, tungsten and molybdenum or tantalum are preferable, since they match the thermal expansion coefficient of ceramics. Also, mixtures and alloys of silver, palladium, platinum and the like may be used.

Also, in order to increase the strength of adhesion to the AlN, an oxide powder may be added. For the oxide powder, oxides of group IIa elements and group IIIa elements, Al₂O₃, SiO₂ and the like are preferable. In particular, yttrium oxide is preferred for its extremely favorable wetting properties with respect to AlN. The amount added of these oxides is preferably 0.1 to 30 wt. %. If it is less than 0.1 wt. %, the strength of adhesion between the metal layer that makes up the formed electrical circuit and the AlN declines. Also, when 30 wt. % are exceeded, the resistance of the metal layer that makes up the electrical circuit becomes large.

Next, these powders are sufficiently mixed, binder and solvent added, producing the electrically conductive paste. Using it, the circuit pattern is formed by screen-printing. The thickness of the electrically conductive paste, measured after drying, is preferably in the range of 5 μm to 100 μm. If the thickness is less than 5 μm, the electrical resistance becomes too large, and also the strength of adhesion declines. Also, if the thickness exceeds 100 μm, the strength of adhesion declines.

Also, preferably the gaps in the pattern of the resistive heating element being formed ideally are at least 0.1 mm. With gaps of less than 0.1 mm, when leading electrical current through the resistive heating element, depending on the applied voltage and the temperature, leak currents arise, causing short circuits. Particularly if used above 500° C. it is preferable to make the pattern gaps wider than 1 mm, and even more preferable if they are at least 3 mm. Also, it is possible to form by screen-printing not only the resistive heating element pattern but also RF electrodes and electrodes for electrostatic chucks.

Next, after having defatted the electrically conductive paste, it is sintered. The degreasing is performed in a non-oxidant atmosphere of nitrogen, argon or the like. The degreasing temperature is preferably at least 500° C. Below 500° C. the binder in the electrically conductive paste is insufficiently removed so that carbon remains in the metal layer, and metal carbides are formed at firing time, which is undesirable.

Ideally, firing is performed in a non-oxidant atmosphere of nitrogen, argon or the like, at a temperature of at least 1500° C. A temperature below 1500° C. is undesirable because grain growth in the electrically conductive paste does not advance, causing the electrical resistance of the metal layer after the firing to become extremely high. Also, it is better if the firing temperature does not exceed the sintering temperature of the ceramics. When firing the electrically conductive paste at a temperature that exceeds the sintering temperature of the ceramics, the auxiliary sintering agent and the like contained in the ceramics begin to be released; furthermore grain growth is promoted and the strength of adhesion between the ceramics and the metal layer diminished.

Next, in order to secure the insulating properties of the metal layer, an insulating coating may be formed on top of the metal layer. Preferably, a material is used for the insulating coating that is identical to the material of the ceramics on which the metal layer has been formed. That is, when the composition of the ceramics and the insulating coating drastically differ, naturally also their thermal expansion coefficients differ and cause problems such as the occurrence of warp after the firing, which is undesirable. For example, in the case of aluminum nitride, a predetermined amount of group IIa, IIIa oxides and carbon-oxygen compounds may be added to the aluminum nitride as auxiliary sintering agent, mixed, to which binder and solvent may be added, a paste made, and applied by screen-printing on top of the metal layer. Preferably the amount of auxiliary sintering agent added at this time is at least 0.01 wt. %. If it is less than 0.01 wt. %, dense packing of the ceramics does not occur, which is undesirable because the effect of securing insulation within the heat-generating element pattern is diminished. Also, it is necessary that the amount of auxiliary agents added not exceed 20 wt. %. When exceeding this range, excessive auxiliary sintering agent infiltrates the metal layer, and can alter the resistance of the resistive heating element, which is undesirable.

Although there are no particular provisions for the thickness of the film to be applied, it is preferably at least 5 μm. A lower film thickness is undesirable because the desired insulating property becomes difficult to achieve.

Also, if a metal with a high melting point, such as W, is used as material for the metal layer, an insulating layer can be formed also by applying crystallized glass and glaze glass, organic resin and the like, followed by firing or hardening. For the type of glass, borosilicate glass, lead oxide, zinc oxide, aluminum oxide, silicon oxide and the like can be used. To these powders organic solvent and binder are added, a paste is made and applied by screen-printing. There are no particular limits to the applied thickness, but it is preferred to be at least 5 μm, as above. This is because below 5 μm, securing the insulating properties becomes difficult. There are no particular limitations for the firing temperature at this time, however, because the metal layer does not have antioxidant properties, a surrounding atmosphere of nitrogen, argon or similarly non-reactive gases is preferable.

Also, as electrically conductive paste, it is also possible to use mixtures and alloys of silver, palladium, platinum and the like. For these metals, because the volume conductivity of the conductor rises when palladium and platinum are added in proportion to the content of silver, their added amount can be adjusted depending on the circuit pattern. Also, because these additives have an effect of preventing migration within the pattern, it is preferable to add 0.1 parts by weight for each 100 parts by weight of silver.

It is preferable that metal oxide is added to these metal powders in order to secure the adhesive properties with respect to AlN. For example, aluminum oxide, silicon oxide, copper oxide, boron oxide, zinc oxide, lead oxide, rare earth oxides, transition metal element oxides, alkaline earth metal oxides and the like may be added. The amount to be added preferably lies in the range of 0.1 wt. % to 50 wt. %. If the content is smaller than this, the adhesive properties with regard to AlN deteriorate, which is undesirable. Also, a content larger than this is undesirable because it obstructs the sintering other metal ingredients, such as silver.

By mixing these metal powders and inorganic material powders, further adding organic solvent and binder, making all into a paste, and screen-printing as described above, a circuit pattern may be formed. In this case, the formed circuit pattern is fired in an atmosphere of a non-reactive gas, such as nitrogen, or in air, in the temperature range of 700° C. to 1000° C.

Furthermore in this case, in order to secure insulation within the circuit, an insulating layer may be formed by applying crystallized glass, glaze glass, organic resin or the like, and firing or hardening. For the type of glass, borosilicate glass, lead oxide, zinc oxide, aluminum oxide, silicon oxide and the like can be used. To these powders, organic solvent and binder are added, a paste is made and applied by screen-printing. There is no particular limitation to the applied thickness, but it is preferable that it is at least 5 μm, as above. This is because below 5 μm, securing the insulating properties becomes difficult.

Also, a firing temperature below the above-mentioned temperature at the time of circuit formation is preferred. When firing at a temperature higher than during the time of circuit formation, the resistance of the circuit pattern is greatly altered, which is undesirable.

Next, depending on necessity, sintered ceramic pieces may be furthermore laminated. The lamination is best performed through an adhesive. For the adhesive, group IIa element compounds, group IIIa element compounds, binder, and solvent are added to aluminum oxide powder and aluminum nitride powder, from which a paste is made and applied by screen-printing or the like to the adhesive faces. While there is no particular limitation regarding the thickness of the adhesive being applied, a thickness of at least 5 μm is preferred. With a thickness of less than 5 μm, adhesion defects such as pinholes and irregularities of adhesion emerge more easily. Because at this time the formed metal layer can react with the adhesive layer, it is furthermore preferable that a protective layer having aluminum nitride as a main component as described above has been formed on the metal layer.

The sintered ceramic pieces on which the adhesive has been applied are defatted at 500° C. in a non-oxidant atmosphere. Afterwards, the sintered ceramic pieces to be laminated are stacked, a fixed pressure is applied, and the sintered ceramic pieces are joined by heating in a non-oxidant atmosphere. Preferably the pressure is at least 5 kPa. With a pressure of less than 5 kPa, sufficient adhesive strength is not obtained, or the aforementioned adhesion defects emerge more easily.

Although there is no particular limitation for the heating temperature for joining, as long as it is a temperature at which the sintered ceramic pieces are sufficiently glued to each other through the adhesive layers, at least 1500° C. is preferred. At less than 1500° C. sufficient adhesive strength is hard to obtain, and adhesion defects easily emerge. For the aforementioned non-oxidant atmosphere at both the time of degreasing and that of joining, using nitrogen, argon or the like is preferred.

With the foregoing, a laminated sintered ceramic piece may be obtained that serves as the heater base plate constituting the heater. It should be added that instead of using electrically conductive paste for the electrical circuit, it is also possible, for example in case of a heater circuit, to use molybdenum wires (coils), or in case of electrodes for electrostatic chucks and RF electrodes, to use molybdenum or tungsten meshes (netlike pieces).

In this case, the foregoing molybdenum coils or meshes may be embedded in the AlN raw material powder, with manufacturing being done by hot-pressing. It suffices if the temperature of the hot-press and the atmosphere are similar to the AlN sintering temperature and atmosphere described above; however a pressure of at least 0.98 MPa applied by the hot-press is desirable. At less than 0.98 MPa, gaps can arise between the AlN and the molybdenum coils or meshes, which can render the heater dysfunctional.

Next, the co-fired method is explained. From the above-mentioned raw material slurry, a sheet is formed according to the doctor blade method. There are no particular limitations regarding the sheet forming, however the thickness of the dry sheet is preferably not more than 3 mm. When the sheet thickness exceeds 3 mm, the amount of dry shrinking of the slurry increases, causing the probability of cracks appearing in the sheet to become higher.

On this sheet, a metal layer making up an electric circuit of predetermined shape is formed by applying electrical conductive paste by screen-printing or a similar technique. As electrically conducting paste, the same paste may be used as described for the post-metallization method. However, in the co-fired method the addition of oxide powder to the electrically conductive paste can be omitted without difficulty.

Next, a sheet where circuit formation has been conducted and a sheet where circuit formation has not been conducted are laminated. As a lamination method both sheets are placed in their prescribed positions and joined by stacking. At this time, depending on necessity, solvent is applied between the sheets. In the state joined by stacking, the sheets are heated as necessary; The heating temperature is preferably not more than 150° C. When heating to a higher temperature, the laminated sheets are severely deformed. Afterwards, the joined sheets are formed into one piece by applying pressure.

The applied pressure is preferably in the range of 1 to 100 MPa. At a pressure of less than 1 MPa, the sheets are not adequately formed into one piece and can come off during the following processes. Also, when applying a pressure exceeding 100 MPa, the deformation of the sheets becomes too large.

This laminated piece is subjected to degreasing treatment and sintering in the same way as in the aforementioned post-metallization method. The temperatures of the degreasing treatment and sintering, the amount of carbon and the like are the same as in the post-metallization method. It is also easy to make an electric heater having a plurality of electrical circuits by, when printing the electrically conductive paste to sheets, printing a heater circuit, electrodes for electrostatic chucks and the like to each of a plurality of sheets, and laminating the sheets. In this way a laminated sintered ceramic piece that becomes the heater base plate constituting the heater may be obtained.

Moreover, if the circuits of the heat-generating element and other electrical circuits are formed on the outermost layers of the laminated ceramic piece, an insulating coating may be formed on top of the electrical circuits in the same way as in the aforementioned post-metallization method, in order to protect the electrical circuits and secure the insulating properties.

In the present invention, the resistive heating element pattern may be divided into a plurality of zones. While there are no particular limitations regarding the shape of the division, a division method is preferred that enables control in such a way that, when the temperature increases in the heater base plate constituting the heater, the temperature distribution in the heater base plate is rendered uniform. More specifically, the division may be between the periphery and the interior. This is preferable because the temperature in the periphery unavoidably becomes higher during a temperature increase, and by reducing power supply compared to the interior, the temperature increase may be performed such that the temperature difference between interior and periphery vanishes as much as possible. A division into two zones is also effective, but considering the temperature distribution, division into three or more zones is preferred. However, when increasing the number of zones, also the number of control devices, power sources and the like increases and becomes a cause of increasing cost. When regarding both, control by two to three zones is preferred. Because particularly in recent time demands with regard to the temperature distribution are stronger, control by three zones is more preferred because of superior isothermal properties.

Also if a wafer is placed at room temperature on a heater base plate constituting a heater that has been heated to a predetermined temperature, the temperature of the interior of the wafer drops, and also in this case the temperature distribution may be decreased by dividing the resistive heating element into a plurality of parts in the form of concentric circles. This is preferable, because by reducing power supply to the periphery, and increasing power supply to the inner circle and center, the temperature distribution in the heater base plate constituting the heater, and thus the temperature of the wafer may be rendered uniform.

As shown in FIG. 2, in accordance with the present invention, a cooling module 3 may further be provided. When it is necessary to cool the heater base plate constituting the heater, the cooling module may abut against the heater base plate, and by absorbing its heat, rapidly cool the heater base plate. This configuration is preferable because it allows a considerable improvement of the cooling speed of the heater base plate and increase throughput. While there are no particular limitations regarding the material of the cooling module, aluminum, copper, and their alloys are used preferably due to their relatively high thermal conductivity. Also, stainless steel, magnesium alloys, nickel, and other metallic materials may be used. Also, in order to provide the cooling module with antioxidant properties, an antioxidant metal film of Ni, Au, or Ag, may be formed by plating or thermal spraying.

Also, ceramics may be used as the material of the cooling module. While in this case there are no particular limitations for the material, aluminum nitride and silicon carbide are preferred because of high thermal conductivity, which enables heat to be quickly absorbed from the heater base plate. Also, silicon carbide and aluminum oxide are preferred for their mechanical strength and superior resiliency. Also, oxide ceramics such as alumina, cordierite, and steatite are preferred for their comparatively low price. As mentioned above, there are many different options in choosing the material for the cooling module; it can be chosen to suit the specific need. Among the choices, nickel-plated aluminum is particularly preferable because it is highly resistant to oxidation, has high thermal conductivity, is light and is relatively inexpensive.

It is also possible to circulate a coolant in the cooling module. This is preferable because by doing so, the heat transferred to the cooling module from the heater base plate may be quickly removed from the cooling module, leading to a further improvement of the cooling speed of the heater base plate. As coolant to be circulated in the cooling module water, fluorinates, and the like, can be chosen, and there is no particular limitation. However, considering the amount of the specific heat and cost, water is most preferable. As a suitable example, two aluminum plates are prepared, and a water flow channel is shaped in one plate by machine processing or the like. Furthermore, the entire surface is plated with nickel to improve corrosion resistance and oxidation resistance. Then the other aluminum plate, having also been nickel-plated, is flatly attached. To avoid water leaking to the surroundings of the flow channels, O-rings and the like are inserted, and the two aluminum plates are flatly attached by fixing screws or welding.

Also, the abutting surfaces should also be flattened so that the sum of the flatness of the surface of the heater base plate that abuts against the cooling module, and that of the cooling module to that abuts against the heater base plate is less than 0.8 mm. A flatness of less than 0.4 mm is particularly preferable. Conventionally, it has been proposed to improve flatness and surface roughness of the main surface of a heater on which objects to be heated are placed, in order to equalize the temperature distribution of the objects to be heated. However, with regard to heater units that have a cooling module, there have been no proposals to equalize temperature distribution and improve cooling speed by improving the flatness of the abutting surfaces of both the heater base plate and the cooling module.

By improving both the flatness of the surface of the heater base plate that abuts against the cooling module, and the flatness of the surface of the cooling module that abuts against the heater base plate, the full surfaces of the heater base plate and the cooling module can uniformly abut each other. As a result, thermal transmissivity is improved because adhesion between both surfaces increases and when the cooling module is attached to the heating body, cooling speed is faster and at the same time the full reverse surface of the heater is uniformly cooled, leading to an improvement in the uniformity of the temperature distribution in the heater at cooling time.

If flattening is ensured only on either the surface of the heater base plate that abuts against the cooling module, or the surface of the cooling module that abuts against the heater base plate, then the abovementioned effect cannot be obtained. The abovementioned effect may be obtained only when the sum of the flatness of the two attaching surfaces is made to be not more than 0.8 mm.

To flatten the respective abutting surfaces of the heater base plate and the cooling module, processing methods such as the known methods of lap polishing or grinding by whetstone can be employed. A surface roughness Rₐ after processing of not more than 5 μm is preferable. By achieving a surface roughness Rₐ of the respective abutting surfaces of the heater base plate and the cooling module of not more than 5 μm, the adhesion of heater base plate and cooling module improves, leading to improvement of the uniformity of the temperature distribution in the heater base plate and of cooling speed.

In particular, when improving the surface roughness of the abutting surface of the heater base plate and approaching a specular condition, the radiability of the surface declines. This is preferable because when the radiability declines, the amount of heat radiated from the surface diminishes, leading to energy savings of the electric power for heating the heater base plate. Also, if the heater base plate is made of ceramic, when the surface roughness is high, fall-off of ceramic grains increases due to friction during abutting against the cooling module and the like, leading to particles that badly influence the quality of the objects being heated. Therefore, a surface roughness that is not more than 1 μm is even more preferable.

Also, in case of a heater where a circuit of a heat-generating element and an insulating layer that protects the circuit of the heat-generating element have been formed on the rear side, when processing in order to flatten the surface abutting against the cooling module is overdone, the thickness of the insulating layer decreases, which depending on the circumstances can lead to the circuit of the heat-generating element becoming exposed, and to the possibility of causing short-circuit accidents. In order to prevent this it suffices to increase the thickness of the insulating layer. However, because the thermal conductivity of the insulating layer often is low, thermal resistance increases with the thickness, and cooling speed declines. Here, the thickness of the insulating layer after flattening is preferably set to 15 μm to 500 μm.

Also, if after flattening the thickness of the insulating layer shows variance, the abovementioned thermal resistance is altered, and due to varying cooling speed, the temperature distribution in the heater base plate tends to become non-uniform. Consequently, the thickness of the insulating layer after flattening is preferably uniform, and the difference between the maximum value and the minimum value of the thickness of the insulating layer is preferably not more than 200 μm.

For example, the cooling module is positioned by an elevation means 7 such as an air cylinder within a casing, in a way that enables it to be abutted to and detached from the heater, depending on necessity. This cooling module is provided with through holes for passing through electrodes 4 for power supply, a temperature measurement means 5, and other feeds.

It is preferable that the isothermal plate has been supplemented with a heating function. By supplementing it with a heating function, temperature variations in the isothermal plate itself can be corrected. By designing the heating function such that the amount of heat generated in the periphery of the isothermal plate becomes large, temperature variations due to heat escaping from the circumference can be corrected.

Also, it is preferable that the heater and cooling module are contained in a metal casing. By being contained in such a casing, the temperature distribution of the heating surface of the heater is no longer disturbed by influence of airflow and the like, which is preferable because it enables to realize a more uniform temperature distribution. Also here, the distance between the containing metal casing and the heater is preferably kept constant. This is because where the heater approaches the casing, the amount of heat transferred to the casing increases, which in turn decreases the temperature of the heating surface, which is undesirable.

Also, because a heating device comprising the heater and cooling module can render the temperature distribution in the heating surface uniform, it may be preferably used in particular in semiconductor manufacturing equipment that heat-treats semiconductor wafers. For example, it may be used as a heater for hardening a resin film formed on the wafer, or a heater for testing semiconductors, or may also be used in equipment for coating, etching, ashing and the like.

### Embodiment 1

100 parts by weight of aluminum nitride powder and 0.6 parts by weight of yttrium stearate powder were mixed, 10 parts by weight of polyvinyl butyrate as binder and 5 parts by weight of dibutyl futarate as solvent were added, and granules were formed by spray-drying, press-formed, defatted in 700° C. nitrogen atmosphere, and sintered at 1850° C. in nitrogen atmosphere to make a piece of sintered aluminum nitride. For this, aluminum nitride powder with an average grain diameter of 0.6 mm and a relative surface area of 3.4 m²/g was used. The piece of sintered aluminum nitride was finished to a diameter of 340 mm and a thickness of 15 mm.

Also, W paste was produced from 100 parts by weight of W powder, using 1 part by weight of Y₂O₃, 5 parts by weight of ethyl cellulose as binder, and butyl carbitol as solvent. A pot mill with three rollers was used for mixing. The W paste was applied by screen-printing to the piece of sintered aluminum nitride, forming a three-zone heater circuit pattern, followed by degreasing at 900° C. in nitrogen atmosphere and sintering at 1800° C. in nitrogen atmosphere. The face where the heater circuit pattern had been formed was coated, excluding electricity feeder parts, with a ZnO—B₂O₃—Al₂O₃ type glass paste at a thickness of 100 μm, followed by firing in nitrogen atmosphere at 700° C. Also, tungsten terminals were attached with gold solder to the electricity feeder parts, and nickel electrodes fastened to the tungsten terminals with screws, completing the heater base plate.

Next, as a cooling module, two plates of pure aluminum with a diameter of 340 mm and a thickness of 5 mm were prepared. The thermal conductivity of the pure aluminum plates is 200 W/mK. In one of the aluminum plates, flow channels of 5 mm width and 3 mm depth for circulating coolant were formed by machining. Furthermore grooves of 2 mm width and 1 mm depth were formed in the perimeter of the flow channels for inserting O-rings. Also, through holes were formed as in- and outlets for the coolant. After inserting an O-ring the two aluminum plates were fixed by fastening with screws. At three locations, through holes were formed in the aluminum plates in order to allow electrodes 4 for supplying electricity and a thermocouple 5 to pass through.

Also, isothermal plates made of copper were prepared with 340 mm diameter and a thickness as shown in Table 1, and a heater was assembled from the heater base plate 1, an isothermal plate 2, and the cooling module 3. The heater was installed in a stainless-steel casing, the heater heated to 130° C. by sending current through the resistive heating element, a wafer thermometer of 300 mm diameter at room temperature was placed on the heating surface, and the temperature was measured after 30 seconds, 60 seconds, and 5 minutes. The difference between the highest temperature and the lowest temperature of the temperatures measured by the wafer thermometer was taken as the temperature distribution and is shown in Table I.

TABLE I

| | Thickness of isothermal plate (mm) | | | | | | |
|---|---|---|---|---|---|---|---|
| | None | 2 | 5 | 10 | 15 | 20 | 30 |
| Temperature | 5 | 2 | 0.5 | 0.3 | 0.10 | 0.15 | 1.3 |
| distribution after 30 | | | | | | | |
| seconds (° C.) | | | | | | | |
| Temperature | 3 | 1.3 | 0.3 | 0.15 | 0.08 | 0.10 | 1.2 |
| distribution after 60 | | | | | | | |
| seconds (° C.) | | | | | | | |
| Temperature | 1.0 | 0.5 | 0.3 | 0.15 | 0.09 | 0.12 | 1.1 |
| distribution after 5 | | | | | | | |
| minutes (° C.) | | | | | | | |

As understood from Table I, when providing an isothermal plate, the temperature distribution improves. In particular, the temperature distribution is particularly outstanding when the thickness of the isothermal plate is within the range of 5 mm to 20 mm.

### Embodiment 2

Apart from changing the material of the isothermal plate into aluminum of a thickness as shown in Table II, the heater was assembled in the same way as in Embodiment 1, and the temperature distribution measured in the same way as for Embodiment 1. The results are shown in Table II.

TABLE II

| | Thickness of isothermal plate (mm) | | | | | | |
|---|---|---|---|---|---|---|---|
| | None | 2 | 5 | 10 | 15 | 20 | 30 |
| Temperature | 5 | 2.5 | 0.7 | 0.4 | 0.15 | 0.20 | 1.7 |
| distribution after 30 | | | | | | | |
| seconds (° C.) | | | | | | | |
| Temperature | 3 | 1.5 | 0.5 | 0.2 | 0.10 | 0.15 | 1.5 |
| distribution after 60 | | | | | | | |
| seconds (° C.) | | | | | | | |
| Temperature | 1.0 | 0.7 | 0.4 | 0.2 | 0.10 | 0.12 | 1.4 |
| distribution after 5 | | | | | | | |
| minutes (° C.) | | | | | | | |

It can be seen that also if aluminum is chosen as the material of the isothermal plate, the temperature distribution is particularly outstanding when the thickness of the isothermal plate is within the range of 5 mm to 20 mm.

### Embodiment 3

Apart from changing the material of the isothermal plate into phosphor bronze of a thickness as shown in Table III, the heater was assembled in the same way as in Embodiment 1, and the temperature distribution measured in the same way as for Embodiment 1. The results are shown in Table III.

TABLE III

| | Thickness of isothermal plate (mm) | | | | | | |
|---|---|---|---|---|---|---|---|
| | None | 2 | 5 | 10 | 15 | 20 | 30 |
| Temperature | 5 | 2.3 | 0.6 | 0.4 | 0.12 | 0.15 | 1.7 |
| distribution after 30 | | | | | | | |
| seconds (° C.) | | | | | | | |
| Temperature | 3 | 1.2 | 0.4 | 0.2 | 0.10 | 0.12 | 1.5 |
| distribution after 60 | | | | | | | |
| seconds (° C.) | | | | | | | |
| Temperature | 1.0 | 0.6 | 0.3 | 0.15 | 0.10 | 0.12 | 1.4 |
| distribution after 5 | | | | | | | |
| minutes (° C.) | | | | | | | |

It can be seen that also if phosphor bronze is chosen as the material of the isothermal plate, the temperature distribution is particularly outstanding when the thickness of the isothermal plate is within the range of 5 mm to 20 mm.

### Embodiment 4

Apart from changing the material of the isothermal plate into an alloy of aluminum and silicon of a thickness as shown in Table IV, the heater was assembled in the same way as in Embodiment 1, and the temperature distribution measured in the same way as for Embodiment 1. The results are shown in Table IV.

TABLE IV

| | Thickness of isothermal plate (mm) | | | | | | |
|---|---|---|---|---|---|---|---|
| | None | 2 | 5 | 10 | 15 | 20 | 30 |
| Temperature | 5 | 2.7 | 0.8 | 0.5 | 0.17 | 0.25 | 1.7 |
| distribution after 30 | | | | | | | |
| seconds (° C.) | | | | | | | |
| Temperature | 3 | 1.7 | 0.6 | 0.3 | 0.13 | 0.17 | 1.5 |
| distribution after 60 | | | | | | | |
| seconds (° C.) | | | | | | | |
| Temperature | 1.0 | 0.9 | 0.5 | 0.2 | 0.12 | 0.15 | 1.4 |
| distribution after 5 | | | | | | | |
| minutes (° C.) | | | | | | | |

It can be seen that also if an alloy of aluminum and silicon is chosen as the material of the isothermal plate, the temperature distribution is particularly outstanding when the thickness of the isothermal plate is within the range of 5 mm to 20 mm.

### Embodiment 5

Apart from selecting alumina (Al₂O₃), silicon nitride (Si₃N₄) and silicon carbide (SiC) for the material of the heater base plate, with Ag—Pd for the heat-generating element, the heater was assembled in the same way as in Embodiment 1, and the temperature distribution measured was in the same way as for Embodiment 1. The thickness of the isothermal plate made of Cu was set to 15 mm. The results are shown in Table V.

TABLE V

Material of the heater base plate

| | AlN | Al₂O₃ | Si₃N₄ | SiC |
|---|---|---|---|---|
| Temperature | 0.1 | 0.5 | 0.35 | 0.2 |
| distribution after 30 | | | | |
| seconds (° C.) | | | | |
| Temperature | 0.08 | 0.4 | 0.25 | 0.15 |
| distribution after 60 | | | | |
| seconds (° C.) | | | | |
| Temperature | 0.09 | 0.45 | 0.3 | 0.12 |
| distribution after 5 | | | | |
| minutes (° C.) | | | | |

It can be seen that the temperature distribution is dependent on the thermal conductivity of the heater material.

### Embodiment 6

Apart from changing, in the AlN heater base plate used in Embodiment 1, the number of zones of the heat-generating element circuit as shown in Table VI, the heater was assembled in the same way as in Embodiment 1, and the temperature distribution was measured in the same way as for Embodiment 1. The results are shown in Table VI. The thickness of the isothermal plate was set to 15 mm.

TABLE VI

Number of zones

| | 1 | 2 | 3 | 4 |
|---|---|---|---|---|
| Temperature | 0.14 | 0.12 | 0.1 | 0.07 |
| distribution after 30 | | | | |
| seconds (° C.) | | | | |
| Temperature | 0.11 | 0.10 | 0.08 | 0.05 |
| distribution after 60 | | | | |
| seconds (° C.) | | | | |
| Temperature | 0.10 | 0.09 | 0.09 | 0.06 |
| distribution after 5 | | | | |
| minutes (° C.) | | | | |

It can be seen that by performing control with multiple zones, the temperature distribution is improved.

### Embodiment 7

The heater base plate with three-zone heat-generation element circuit used in Embodiment 6 was used and its temperature was increased until 150° C., a cooling module was abutted and the temperature of the wafer after 1 minute was measured. Further, the temperature distribution of the wafer at that time was measured, and finally the time until the average temperature of the wafer reached 70° C. was measured. Measurement was executed both for the case of circulating cooling water in the cooling module, and for the case of not circulating the same. For comparison, measurement was also executed when the cooling module was not abutted. The results are shown in Table VII.

TABLE VII

| | Cooling module | | |
|---|---|---|---|
| | Not abutted | Abutted | Abutted |
| Water cooling | — | No | Yes |
| Temperature after 1 minute | 145 | 120 | 92 |
| (° C.) | | | |
| Temperature distribution | 2.1 | 1.9 | 1.8 |
| (° C.) | | | |
| Time until temperature | 32 | 7 | 4 |
| reaches 70° C. (minutes) | | | |

It can be seen that by abutting a cooling module, the temperature of the wafer can be reduced quickly and that cooling can be made more effective by circulating cooling water in the cooling module.

### Embodiment 8

The AlN heater base plate used in Embodiment 1, isothermal plates made of Cu with respective thicknesses of 5 mm and 15 mm, and a cooling module were installed in a metal casing, and photolithographic treatment was performed. The resist used was a super-high resolution resist for use with 248 nm wavelength KrF excimer laser steppers, prebake for 90 seconds at 130° C. and exposure bake for 90 seconds at 130° C. were performed, and the line width variation (3σ) of the 130 nm node were measured. The results are shown in Table VIII.

TABLE VIII

| | Thickness | | |
|---|---|---|---|
| | None | 5 mm | 15 mm |
| Pattern accuracy (±nm) | 11 | 5 | 2 |

With growing thickness of the isothermal plate its isothermal properties become better, and the resist pattern accuracy improves. Therefore, it can be seen that the heater of the present invention is suitable as hotplate for coaters/developers.

### Embodiment 9

The AlN heater base plate of Embodiment 1, a Cu isothermal plate of 15 mm thickness, and a cooling module were used, and an isothermal plate heater comprising a stamped-out stainless steel heat-generation element confined between two mica sheets was arranged on the rear side of the isothermal plate. In order to compensate the temperature decline at the periphery of the Cu isothermal plate, the stamped-out stainless steel heat-generating element was designed such that the amount of heat it generates is larger at the periphery. The above was installed in a metal casing in the same way as in Embodiment 8, and the resist pattern accuracy measured. The results are shown in Table IX.

TABLE IX

Isothermal
plate heater

| | No | Yes |
|---|---|---|
| Temperature distribution after 30 seconds | 0.1 | 0.05 |
| (° C.) | | |
| Temperature distribution after 60 seconds | 0.08 | 0.04 |
| (° C.) | | |
| Accuracy of pattern (±nm) | 2 | 1 |

It can be seen that the temperature distribution improves, and also the pattern accuracy becomes better if an isothermal plate heater that heats the isothermal plate is provided.

### Embodiment 10

Isothermal plates were prepared by respectively applying Ni plating and Ni plating followed by Au plating to isothermal plates identical to the Cu isothermal plate of Embodiment 9. These were installed in a metal casing in the same way as in Embodiment 9. A cycle of heating the heater base plate from room temperature (25° C.) until 200° C., abutting the cooling module and cooling to room temperature, and again heating until 200° C. was repeated 2000 times. The results of observing the surface condition of the Cu isothermal plates after 2000 cycles are shown in Table X. The temperature distribution shown in Table 10 is that of cycle number 2000.

TABLE X

| | Plating | | |
|---|---|---|---|
| | None | Ni | Ni/Au |
| Temperature | 0.1 | 0.1 | 0.1 |
| distribution after 30 | | | |
| seconds (° C.) | | | |
| Temperature | 0.08 | 0.08 | 0.08 |
| distribution after 60 | | | |
| seconds (° C.) | | | |
| Surface condition | With surface | Without | Without |
| | ablation | surface | surface |
| | | ablation | ablation |

For plates to which Ni plating, or Ni plating followed by Au plating, has been applied, there is no surface ablation. In comparison, for plates to which plating has not been applied, it can be seen that on the Cu surface a thin oxide layer is formed, which detaches, causing emergence of particles.

### INDUSTRIAL APPLICABILITY

According to the present invention, by positioning an isothermal plate with respect to a heater, the temperature distribution in the heater may be made more uniform; in particular the temperature distribution in periods of transition may be made uniform. Also, in the stationary state as well a uniform temperature distribution may be realized. Because in semiconductor manufacturing equipment and testing equipment, flat display panel manufacturing and testing equipment, or photoresist heat treatment equipment in which such a heater is installed the temperature distribution in the heater is rendered more uniform than in conventional equipment, improvement of special characteristics, yield rate, and reliability, or the degree of integration and image quality of semiconductors and flat display panels are achieved.

What is claimed is:

1. A heater for semiconductor manufacturing equipment, the heater having a heating surface for heating a heating-subject article placed on or separated a fixed distance from the heating surface, characterized in having a resistive heating element on a surface of or inside a base material constituting the heater, and in having an isothermal plate, a main component of which being copper or copper alloy, along the heater side opposite said heating surface.

2. A heater for semiconductor manufacturing equipment, the heater having a heating surface for heating a heating-subject article placed on or separated a fixed distance from the heating surface, characterized in having a resistive heating element on a surface of or inside a base material constituting the heater, and in having an isothermal plate, a main component of which being aluminum or aluminum alloy, along the heater side opposite said heating surface.

3. A heater for semiconductor manufacturing equipment as set forth in claim 1, wherein an antioxidant coating is formed on a surface of the isothermal plate.

4. A heater for semiconductor manufacturing equipment as set forth in claim 2, characterized in that an antioxidant coating is formed on a surface of the isothermal plate.

5. A heater for semiconductor manufacturing equipment as set forth in claim 3, characterized in that the antioxidant coating comprises nickel as a main component.

6. A heater for semiconductor manufacturing equipment as set forth in claim 4, characterized in that the antioxidant coating comprises nickel as a main component.

7. A heater for semiconductor manufacturing equipment as set forth in claim 1, characterized in that the isothermal plate has a thickness of at least 5 mm.

8. A heater for semiconductor manufacturing equipment as set forth in claim 2, characterized in that the isothermal plate has a thickness of at least 5 mm.

9. A heater for semiconductor manufacturing equipment as set forth in claim 1, characterized in that the isothermal plate has a thickness of at most 20 mm.

10. A heater for semiconductor manufacturing equipment as set forth in claim 2, characterized in that the isothermal plate has a thickness of at most 20 mm.

11. A heater for semiconductor manufacturing equipment as set forth in claim 1, characterized in that the base material constituting the heater comprises aluminum nitride as a main component.

12. A heater for semiconductor manufacturing equipment as set forth in claim 2, characterized in that the base material constituting the heater comprises aluminum nitride as a main component.

13. A heater for semiconductor manufacturing equipment as set forth in claim 1, characterized in that the resistive heating element is divided into a plurality of zones, and each zone can be independently controlled.

14. A heater for semiconductor manufacturing equipment as set forth in claim 2, characterized in that the resistive heating element is divided into a plurality of zones, and each zone can be independently controlled.

15. A heater for semiconductor manufacturing equipment as set forth in claim 1, further comprising a cooling module.

16. A heater for semiconductor manufacturing equipment as set forth in claim 2, further comprising a cooling module.

17. A heater for semiconductor manufacturing equipment as set forth in claim 15, characterized in that a coolant is enabled to circulate in the cooling module.

18. A heater for semiconductor manufacturing equipment as set forth in claim 16, characterized in that a coolant is enabled to circulate in the cooling module.

19. A heater for semiconductor manufacturing equipment as set forth in claim 1, characterized in that the isothermal plate is supplemented with a heating function.

20. A heater for semiconductor manufacturing equipment as set forth in claim 2, characterized in that the isothermal plate is supplemented with a heating function.

21. A heater for semiconductor manufacturing equipment as set forth in claim 19, characterized in that heat generation capacity of the heating function of the isothermal plate is large at a periphery of the isothermal plate.

22. A heater for semiconductor manufacturing equipment as set forth in claim 20, characterized in that heat generation capacity of the heating function of the isothermal plate is large at a periphery of the isothermal plate.

23. A heating device for semiconductor manufacturing equipment, characterized by housing in a metal container a heater for semiconductor manufacturing equipment as set forth in claim 1.

24. A heating device for semiconductor manufacturing equipment, characterized by housing in a metal container a heater for semiconductor manufacturing equipment as set forth in claim 2.
